(19) United States
(12) Patent Application Publication
(10) Pub. No.: US 2005/0161332 A1
(43) Pub. Date: Jul. 28, 2005

(54) Method and apparatus to improve the concentration detection sensitivity in isoelectric focusing systems

(76) Inventor: Gyula Vigh, Magnolia, TX (US)

Correspondence Address: MALLINCKRODT & MALLINCKRODT, 10 EXCHANGE PLACE, SUITE 510, SALT LAKE CITY, UT, 84111, US

(21) Appl. No.: 10/763,981

(22) Filed: Jan. 23, 2004

(51) Int. Cl. B01D 57/02

(52) U.S. Cl. 204/548; 205/644

(57) ABSTRACT

Isoelectric focusing systems are used to analyze ampholytic analytes in a sample. These systems use an electrophoretically generated pH gradient to separate components according to their isoelectric points. This invention overcomes two shortcomings associated with these systems. First, the invention enables the detection of ampholytic analytes whose original concentration in a sample is so low that their concentration after focusing is below their respective detection limit. Auxiliary agents are added to the sample and auxiliary compartments are connected to the separation compartment to increase the final concentration of the focused ampholytic analytes in the separation compartment above their respective detection limit. The second limitation the invention overcomes is the detrimental effects of salt in a sample. Salt alters the pH gradient developed in the separation compartment during focusing compared to the pH gradient obtained for a salt-free sample, thus skewing the electropherogram obtained in the isoelectric focusing separation. This invention eliminates the problems caused by salt-induced shift of the pH gradient by accumulating, during isoelectric focusing, components of salt in the sample and the added auxiliary agents in an auxiliary compartment connected to the separation compartment. By adjusting the amount of auxiliary agent so that at the end of the focusing step no salt or auxiliary agent is located in the separation compartment, one can maintain the correct shape of the pH gradient in the separation compartment, increase the concentration of the focused ampholytic analyte above its respective detection limit and avoid the unwanted effects of salt in the sample.

### BACKGROUND OF THE INVENTION

1. Field

The invention is in the field of isoelectric focusing (IEF) separations, and more particularly, the improvement of the concentration detection limits in the separation of ampholytic components in complex mixtures by isoelectric focusing.

2. State of the Art

Isoelectric focusing systems, and in particular capillary isoelectric focusing systems, are used by researchers to separate ampholytic components in a sample. They are used, for example, to analyze samples obtained in research labs, pharmaceutical manufacturing facilities, and hospitals. This analytical method has become an important tool in bioanalytical chemistry as it allows the separation of ampholytic components not generally possible with more conventional means such as liquid chromatography.

Isoelectric focusing systems operate by creating a pH gradient across a carrier ampholyte-filled separation system, such as a gel or a capillary, by electrophoresis. (For a monograph on gel-based IEF, see, e.g., P. G. Righetti, Isoelectric focusing: theory, methodology and applications, Elsevier Biomedical, Amsterdam, 1983, which is herein incorporated by reference. For a recent monograph on capillary isoelectric focusing (CIEF) see, e.g, Colin F. Poole, The Essence of Chromatography, Chapter 6.8, Elsevier, Amsterdam, 2003, which is herein incorporated by reference.) The electric field forces the ampholytic components in a sample to migrate across the pH gradient to their isoelectric points (pI value). Once separation is deemed complete, the separated components need to be detected: in gel-based IEF, the separated components are typically stained, in CIEF, the content of the separation capillary is mobilized through a detection window to record, typically, the absorbance of the solution by a point detector. The position of the band of an ampholytic sample component in the pH gradient is related to its identity (pI value) while the color intensity of the stained bands in the gel or the absorbance of the band in the point detector window is related to the concentration of the ampholytic sample component. In CIEF, the shape of the separation compartment is typically not critical, though it is advantageous to have a large aspect ratio separation compartment wherein the aspect ratio of the separation compartment is defined as the ratio of the length of the separation compartment and the square root of its cross sectional area. Typically, the aspect ratios used are greater than 10, preferably greater than 100, eminently greater than 1000. The shape of the cross section of the separation compartment can be circular, square, rectangular, oval, etc.. The separation compartment can be implemented as a tube, or as a channel created in, a substantially flat substrate, such as in a separation chip. For the sake of simplicity, the term capillary will be used in this application to describe the separation compartment.

A practical drawback of the CIEF systems is that upon completion of focusing, the content of the separation capillary must be mobilized through the point detection window to effect detection of the separated components.

Imaging capillary isoelectric focusing (iCIEF) systems also achieve separation of the ampholytic components, but do not require post-focusing mobilization of the content of the separation capillary for detection. An iCIEF apparatus generally consists of two electrode compartments, an anode compartment and a cathode compartment, attached to opposite ends of a separation capillary with electrodes positioned in each electrode compartment, an injection device to inject a sample into the separation capillary, a light generating device to shine light through the separation capillary, and a detection device for detecting the intensity of light passing through the entire length or part of the separation capillary as a function of longitudinal position in the separation capillary. A voltage applied between the electrodes establishes the pH gradient in the carrier ampholyte-filled separation capillary and causes separation of the ampholytic sample components. The anode compartment is generally filled with an acidic solution and the cathode compartment is generally filled with a basic solution. The electrode compartments may be separated from the capillary by ion-permeable anti-convective barriers, such as membranes, in order to eliminate convective mixing between the contents of the separation capillary and the adjacent electrode compartment. U.S. Pat. Nos. 5,395,502 and 5,985,121, incorporated herein by reference, describe iCIEF apparatus. Such apparatus is commercially available from Convergent Bioscience Ltd. of Toronto, Canada, as a Model iCE280 instrument. Such instruments work well in detecting the presence of an ampholytic component in a sample, particularly when the concentration of the component in the tested sample is relatively high. However, detecting the presence of a low concentration analyte in a mixture can be difficult, requiring the increase of the analyte's concentration before isoelectric focusing to make detection possible. Increasing the optical path length by increasing the diameter of the separation capillary does not reasonably fix the problem of low concentration detection limit because Joule-heat dissipation becomes worse as the diameter of the separation capillary increases and the separation quality deteriorates. Currently, the problem of low analyte concentration is mitigated by complex and time-consuming procedures such as partial or full removal of the original solvent to increase the concentration of the sample, or by solid-phase extraction or solid-phase micro-extraction followed by desorption of the analytes in a smaller solvent volume to increase their concentration.

Salt in the sample also causes problems in IEF as it alters the intended shape of the pH gradient, yielding irreproducible results. This problem is currently handled by using dialysis or size exclusion chromatography to reduce the salt content of the original sample. These current fixes are time-consuming and complex. A need exists for an easier solution.

### SUMMARY OF THE INVENTION

This invention provides a method and apparatus that improves the concentration detection limits in isoelectric focusing systems, including conventional capillary isoelectric focusing (CIEF) systems and imaging capillary isoelectric focusing (iCIEF) systems, and eliminates the detrimental effects caused by salts that may be present in samples analyzed by isoelectric focusing.

The inventor has found that the concentration detection limit in CIEF and iCIEF systems is improved when the sample holding volume of the IEF system is increased by adding an auxiliary compartment to at least one end, and preferably both ends, of the separation capillary, especially when the use of the added auxiliary compartment is combined with the addition of at least one auxiliary agent, such as a suitable strong electrolyte, weak electrolyte, or ampholytic substance, to the sample. The auxiliary agent is added so that during isoelectric focusing the auxiliary agent substantially forces the ampholytic sample components from the auxiliary compartment into the separation capillary where detection takes place. This increases the concentration of the ampholytic sample components in the separation capillary, thereby improving the concentration detection limit in the capillary isoelectric focusing system. Adding an auxiliary agent without an auxiliary compartment or an auxiliary compartment without an auxiliary agent will work to improve the concentration detection limit, although not as effectively. The preferred auxiliary agents are ampholytic components.

When the auxiliary agent is an ampholytic compound, it should have an isoelectric point either lower than or higher than the isoelectric points of all of the ampholytic components of interest in the sample. The type of auxiliary agent that should be used depends on the sample. Some proteins become denatured in the presence of strong acids or bases, thus making the use of ampholytic or weak electrolyte auxiliary agents a better choice. The amount of auxiliary agent added to the sample should be sufficient to cause displacement of all ampholytic sample components of interest from the additional sample holding volumes of the auxiliary compartments into the separation capillary, but not as large as to make the auxiliary agent itself enter the separation capillary. Since at the end of the separation the sample is present in a much smaller volume (that of the separation capillary) than the original volume (that of the sum of the volumes of the auxiliary compartments and the separation capillary), the concentration of the components of interest is effectively increased and component peaks in the electropherogram that were originally too small to be detected become detectable. This makes analyte detection in CIEF or iCIEF analysis of dilute samples feasible.

The added auxiliary agent can also be used to shift the position of the focused analyte bands in the separation capillary and, as a result, change their peak locations in the electropherogram. A researcher can detect components of interest in the sample that would normally be at the ends of the separation capillary by shifting their focusing positions towards the center of the separation capillary. Before shifting, components at the end of the separation capillary may be undetectable because in CIEF they may focus past the detector window or in iCIEF the beam of light would not pass through that section of the capillary, or, if the light would pass through that section of the capillary, the component may not be in range of the detector and would not appear in the electropherogram. Shifting the focused bands towards the center moves their focusing position in the separation capillary within the range of both the beam of light and detector allowing previously undetectable components to be displayed in the electropherogram.

The ability of the auxiliary agent, in combination with the auxiliary compartment, to shift the position of the focused bands of the ampholytic sample components is extremely important because it can be used to correct the detrimental effects of uncontrolled amounts of salt that may be present in the sample. With the known separation capillary that extends directly into the electrode compartments as shown in cited U.S. Pat. Nos. 5,395,502 and 5,985,121, acids and bases formed from the uncontrolled amount of salt present in the sample occupy a segment at the anodic and cathodic ends of the separation capillary, compress the pH gradient in the separation capillary in an uncontrolled manner, and cause the focused bands in the separation capillary (and, consequently, their corresponding peaks in the electropherogram) to shift from where one would expect to find them.

The combined use of an auxiliary compartment and the controlled addition of an auxiliary agent can eliminate the unpredictable shifting effect of the uncontrolled salt content of the sample. By adjusting the amount of auxiliary agent added to the sample one can insure that the bands of the ampholytic sample components focus at their proper, desired positions. Preferably, the amount of auxiliary agent added will be such that the combined effects of the unknown amount of salt originally present in the sample and the auxiliary agent added to the sample will substantially cause the components of interest to focus in the desired portion of the separation capillary.

In all cases, the needed auxiliary compartment is added between the separation capillary and an electrode compartment with the auxiliary compartment open to the separation capillary for fluid flow and separated from the electrode compartment by an ion-permeable anti-convective barrier, such as a membrane. The extra volume of the auxiliary compartment is added to the part of the separation capillary that is normally in contact with the electrode compartments. The separation capillary and the auxiliary compartment can be formed from a single piece of material or of separate pieces.

In a preferred embodiment of the invention, two auxiliary compartments are added to the isoelectric focusing apparatus at opposite ends of the separation capillary. The preferred auxiliary agents are isoelectric compounds. Preferably, two auxiliary agents are added to the mixture, an anodic agent with an isoelectric point lower than the isoelectric point of any component of interest in the sample and a cathodic agent with an isoelectric point higher than the isoelectric point of any component of interest in the sample. The auxiliary agents can either absorb light at the detection wavelength or can be transparent. The preferred embodiment uses anodic and cathodic auxiliary agents that absorb light at the detection wavelength. This simplifies the determination of the amount of auxiliary agent that needs to be added to the sample to ensure that the desired amount of the auxiliary agent is located in the auxiliary compartments, not in the separation capillary.

The number of suitable auxiliary agents and their combinations are enormous. Tests have been successfully performed with auxiliary agents that do not absorb light at the selected detection wavelength, such as N,N-dimethyliminodiacetic acid, N-methylaminodiacetic acid, iminodiacetic acid, aspartic acid, glutamic acid, omithine, lysine, and arginine. Several auxiliary agents that do absorb light at the selected detection wavelength have also been tested including N-benzyl-N-methylaminodiacetic acid and N-(p-nitrobenzyl)-N-methylaminodiacetic acid. Non-electrolyte, zwitterionic, or ampholytic components needed for the solubilization of any of the sample components (e.g., urea, TWEEN, ND 14, etc.) or for the improvement of their isoelectric focusing separation by complexation (e.g., chiral resolving agents such as cyclodextrins and their derivatives) can be added without altering the principles of the invention.

### THE DRAWINGS

The best mode presently contemplated for carrying out the invention is illustrated in the accompanying drawings in which:

FIG. 1 shows a typical pH gradient created during an isoelectric focusing separation of a mixture containing only carrier ampholytes and ampholytic sample components, no salts or added auxiliary agent, in a capillary isoelectric focusing system comprising only an anode compartment, a separation capillary, and a cathode compartment;

FIG. 2 shows a typical pH gradient created during isoelectric focusing separation of a mixture containing only carrier ampholytes, ampholytic sample components, an added anodic ampholytic auxiliary agent, and an added cathodic ampholytic auxiliary agent, but no salts, in a capillary isoelectric focusing system comprising only an anode compartment, a separation capillary, and a cathode compartment, wherein the added auxiliary agents force the carrier ampholytes and the ampholytic sample components into the central part of the separation capillary, thereby reducing the volume available to them and increasing their concentration and the slope of the pH gradient;

FIG. 3 shows a typical pH gradient created during isoelectric focusing separation of a mixture containing only carrier ampholytes, ampholytic sample components, an added anodic ampholytic auxiliary agent, and an added cathodic ampholytic auxiliary agent, but no salts, in a capillary isoelectric focusing system comprising an anode compartment, an anodic auxiliary compartment, a separation capillary, a cathodic auxiliary compartment, and a cathode compartment, wherein the combination of the added auxiliary compartments between the separation capillary and electrode compartments and the added auxiliary agents leads to the same pH gradient in the separation capillary as shown in FIG. 1, thus maintaining the quality of the isoelectric focusing separation;

FIG. 4 shows a typical pH gradient created during isoelectric focusing separation of a mixture containing carrier ampholytes, ampholytic sample components, an added anodic ampholytic auxiliary agent, an added cathodic ampholytic auxiliary agent, and salts, in a capillary isoelectric focusing system comprising an anode compartment, an anodic auxiliary compartment, a separation capillary, a cathodic auxiliary compartment, and a cathode compartment, wherein the unknown amount of salt in the sample alters the shape of the pH gradient in the separation capillary compared to that in FIG. 1, even if auxiliary agents are added to the sample;

FIG. 5 shows a pH gradient created during isoelectric focusing separation of a mixture containing carrier ampholytes, ampholytic sample components, an added anodic ampholytic auxiliary agent, an added cathodic ampholytic auxiliary agent, and salts, in a capillary isoelectric focusing system comprising an anode compartment, an anodic auxiliary compartment, a separation capillary, a cathodic auxiliary compartment, and a cathode compartment, wherein the amount of auxiliary agent added to the sample is modified in order to eliminate the change in the shape of the pH gradient that was shown in FIG. 4;

FIG. 6 shows an electropherogram of a chicken egg white sample taken without the addition of an auxiliary agent (top panel) compared to an electropherogram of a chicken egg white sample taken with a cathodic auxiliary agent added (bottom panel) demonstrating the pH gradient shifting and compressing effect of the cathodic auxiliary agent;

FIG. 7 shows an electropherogram of a chicken egg white sample taken without the addition of an auxiliary agent (top panel) compared to an electropherogram of a chicken egg white sample taken with an anodic auxiliary agent added (bottom panel) demonstrating the pH gradient shifting and compressing effect of the anodic auxiliary agent;

FIG. 8 shows an electropherogram of a chicken egg white sample taken without the addition of an auxiliary agent (top panel) compared to an electropherogram of a chicken egg white sample taken with both an anodic and a cathodic auxiliary agent added (bottom panel) demonstrating the pH gradient shifting and compressing effect of the auxiliary agents;

FIG. 9 shows an electropherogram of a sample containing DNS-Asp, DNS-Phe, DNS-Trp, terbutaline, and tyramine as components of interest in a pH 3-10 Ampholine carrier ampholyte solution and no added auxiliary agent;

FIG. 10 shows an electropherogram of a sample used to obtain FIG. 9 but with iminodiacetic acid and arginine added as an anodic and cathodic auxiliary agent respectively to compress the pH gradient and make the components of interest appear in the electropherogram;

FIG. 11 shows an electropherogram of a sample used to obtain FIG. 10 which now contains 150 mM of NaCl to demonstrate the pH gradient shifting effect of salt on the electropherograms;

FIG. 12 shows an electropherogram of a sample used to obtain FIG. 11 to which a reduced amount of auxiliary agent has been added to compensate for the effects of salt present in the sample;

FIG. 13 shows a schematic representation of an apparatus that can be used to practice the invention; and

FIG. 14, in the top panel, shows an electropherogram of a sample containing DNS-Trp, DNS-GABA, and labetalol as ampholytic sample components of interest in a pH 3-10 Ampholine carrier ampholyte solution, N-(p-nitrobenzyl)-N-methylaminodiacetic acid as an anodic auxiliary agent, tyramine as a cathodic auxiliary agent, obtained in an iCIEF system equipped with a conventional separation capillary that does not contain auxiliary compartments, and, in the bottom panel, shows an electropherogram of the same sample as in the top panel, but now obtained in an iCIEF system equipped with a separation capillary attached to an anodic auxiliary compartment and a cathodic auxiliary compartment according to FIG. 13.

### DETAILED DESCRIPTION OF THE ILLUSTRATED EMBODIMENT

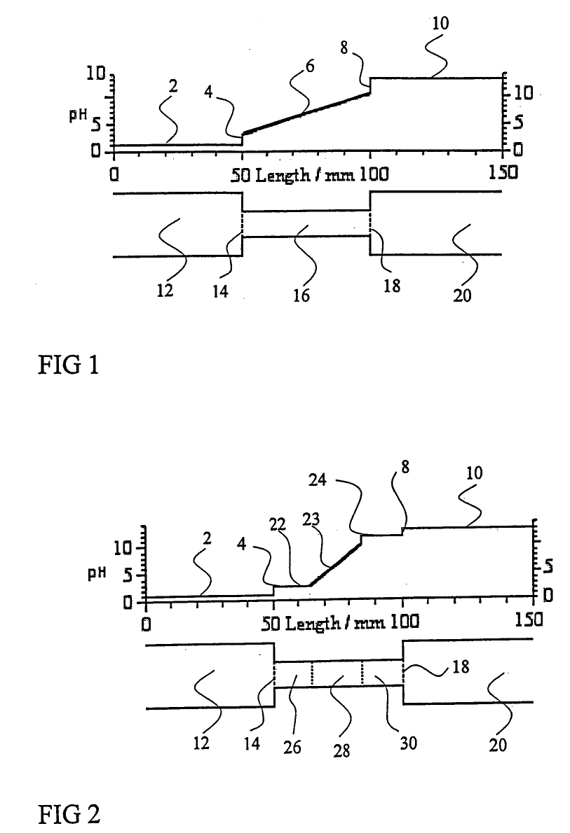

FIG. 1 shows a typical pH gradient created during a capillary isoelectric focusing separation of a mixture containing only carrier ampholytes, and ampholytic sample components, no salts or added auxiliary agents, in a capillary isoelectric focusing system comprising only an anode compartment, a separation capillary, and a cathode compartment. A sufficient amount of acid was added to the anode compartment, 12, to produce a hydronium concentration of 0.1 M. The pH, shown by line 2, is approximately constant across the anode compartment. The cathode compartment, 20, is filled with a base. This particular base produced a hydroxide ion concentration of 0.1 M. Like the anolyte pH, the pH is approximately constant across the cathode compartment, as shown by line 10. As a result of an isoelectric focusing separation, the pH quickly rises where the anode compartment and the separation capillary meet, at 14, as shown by line 4. The pH increases approximately linearly across the length of the separation capillary, 16, shown by line 6, with a quick rise at line 8 where the cathode compartment and the separation capillary meet, at 18.

FIG. 2 shows a typical pH gradient created during isoelectric focusing separation of a mixture containing only carrier ampholytes, ampholytic sample components, an added anodic ampholytic auxiliary agent, and an added cathodic ampholytic auxiliary agent, but no salts, in a capillary isoelectric focusing system comprising only an anode compartment, a separation capillary and a cathode compartment. FIG. 2 illustrates that upon isoelectric focusing, the added two isoelectric auxiliary agents have forced the carrier ampholytes and the sample into the central part, 28, of the separation capillary, into a smaller volume than in FIG. 1, causing, compared to FIG. 1, an increase in the slope of the pH gradient as shown by line 23. The two isoelectric auxiliary agents added were an anodic auxiliary agent with an isoelectric point lower than those of the sample components of interest and a cathodic auxiliary agent with an isoelectric point higher than those of the sample components of interest. The anodic auxiliary agent occupies a section of the capillary, 26, adjacent to the anode compartment, the cathodic auxiliary agent occupies a section of the capillary, 30, adjacent to the cathode compartment. The pH values across the regions of the separation capillary occupied by the isoelectric auxiliary agents are approximately constant and equal to the pI values of the auxiliary agents, shown by line 22. and 24.

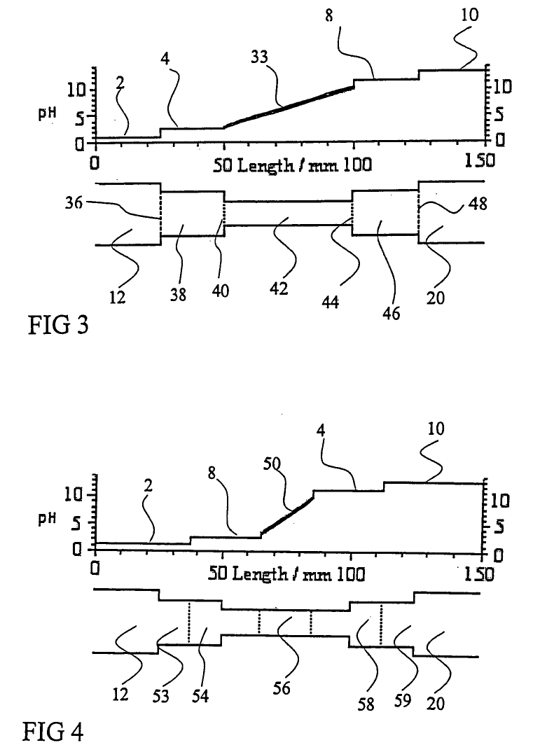

FIG. 3 shows a typical pH gradient created during isoelectric focusing separation of a mixture containing only carrier ampholytes, ampholytic sample components, an added anodic ampholytic auxiliary agent, and an added cathodic ampholytic auxiliary agent, but no salts, in a capillary isoelectric focusing system comprising an anode compartment, an anodic auxiliary compartment, a separation capillary, a cathodic auxiliary compartment, and a cathode compartment. FIG. 3 illustrates the effect of adding two auxiliary compartments, 38 and 46, to the isoelectric focusing apparatus. In this example, the auxiliary compartments are created by tubes attached to the separation capillary, 42, such that fluid can flow through elements 38, 42, and 46. The volume of the separation capillary is Vsep. In this example, the diameter of the attached tubes is larger than the diameter of the separation capillary. The auxiliary compartments are separated from the electrode compartments by membranes, line 36 and 48. Prior to isoelectric focusing, the auxiliary compartments and the separation capillary are filled with the carrier ampholytes, the sample components, and the auxiliary agents.

After isoelectric focusing separation, the anodic auxiliary agent is present in the auxiliary compartment, 38, closest to the anode with a volume of Vauxanode, the cathodic auxiliary agent is present in the auxiliary compartment, 46, closest to cathode with a volume of Vauxcathode, and the carrier ampholytes and the sample are present in the separation capillary.

After isoelectric focusing, the concentration of the carrier ampholytes and the ampholytic sample components is enhanced in the separation capillary by a factor of (Vauxanode+Vsep+Vauxcathode)/Vsep. The enhancement factor can easily be altered by changing the volumes of the auxiliary compartments, 38 and 46. Because the separation capillary is only occupied by the carrier ampholytes and components of the sample, and not by any of the auxiliary agents, the resulting electropherogram will have the same quality as that of a sample without any auxiliary agent, except that the height of the peaks corresponding to the analytes will be larger.

FIG. 4 shows a typical pH gradient created during isoelectric focusing separation of a mixture containing carrier ampholytes, ampholytic sample components, an added anodic ampholytic auxiliary agent, an added cathodic ampholytic auxiliary agent, and salts, in a capillary isoelectric focusing system comprising an anode compartment, an anodic auxiliary compartment, a separation capillary, a cathodic auxiliary compartment, and a cathode compartment. FIG. 4 illustrates how the shape of the pH gradient generated during isoelectric focusing is changed by salt that is present in the sample. Like in FIG. 3, two auxiliary compartments are attached to the separation capillary and two isoelectric auxiliary agents are added to the mixture of carrier ampholytes and the sample. Upon isoelectric focusing, salt, such as NaCl, that was present in the sample causes a compression of the pH gradient in the separation capillary, line 50, because an acid, such as HCl is formed from the salt during electrophoresis and that acid is now present in the first part, 53, of the auxiliary compartment at the anodic side of the separation capillary. Likewise, a base, such as NaOH, that was formed from the salt during electrophoresis is now present in the first part, 59, of the auxiliary compartment at the cathodic side of the separation capillary. Since the auxiliary compartments are now partially filled with acid and base formed during electrophoresis, parts of the auxiliary agents that without the acid and base formed during electrophoresis would have filled the auxiliary compartments are now forced into the end portions of the separation capillary. The anodic auxiliary agent is now present in space 54 which takes up a portion of the auxiliary compartment near the anode and an end portion of the separation capillary, while the cathodic auxiliary agent is now present in space 58 which takes up a portion of the auxiliary compartment near the cathode and an end portion of the separation capillary. Since part of the volume of the separation capillary is taken up by the auxiliary agents, less volume, 56, is available for the carrier ampholytes and components of the sample. This compression of the pH gradient in the separation capillary will cause the peak resolution in the electropherogram to be poorer.

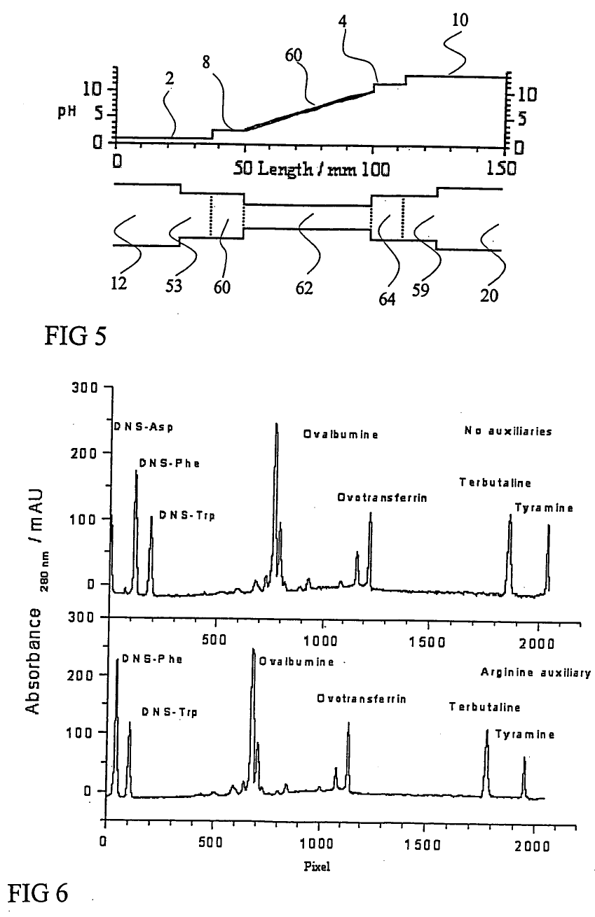

FIG. 5 shows a pH gradient created during isoelectric focusing separation of a mixture containing carrier ampholytes, ampholytic sample components, an added anodic ampholytic auxiliary agent, an added cathodic ampholytic auxiliary agent, and salts, in a capillary isoelectric focusing system comprising an anode compartment, an anodic auxiliary compartment, a separation capillary, a cathodic auxiliary compartment, and a cathode compartment. FIG. 5 shows that by adjusting the amount of the auxiliary agents used, one can compensate for the presence of salt in the sample. In FIG. 5, the salt concentration of the sample is the same as in FIG. 4, but the amount of auxiliary agents added to the sample has been reduced to such an extent that after isoelectric focusing, the auxiliary agents only occupy sections 60 and 64 of the auxiliary compartments. Because only the carrier ampholytes and the sample components are now in the separation capillary, 62, the electropherogram will be similar to what was obtained in FIG. 3, i.e., the detrimental changes caused by the presence of salt in the sample will have been eliminated.

The auxiliary agents added can absorb light at the wavelength of detection or can be transparent, but there is an advantage in iCIEF to using ultraviolet absorbing agents, because of the ease of determining the appropriate amounts of auxiliary agent needed in the sample. As soon as the boundaries of the added UV absorbing auxiliary agents are observed, a sufficient amount of auxiliary agent has been added. If no boundaries are observed then insufficient amounts of auxiliary agents have been added. If the boundaries penetrate too far into the capillary, the amount of auxiliary agent added is too high and needs to be reduced.

The addition of any non-electrolyte does not change the principles of this invention. Zwitterionic components can also be added to the sample for solubilization or to improve their isoelectric focusing separation without altering the principle effects of the auxiliary agent.

### EXAMPLE 1

FIG. 6 shows an iCIEF electropherogram of a chicken egg white sample taken without the addition of an auxiliary agent (top panel) compared to an iCIEF electropherogram of a chicken egg white sample taken with a cathodic auxiliary agent added (bottom panel) and demonstrates the effect of adding a cathodic auxiliary agent to the sample. The main components of chicken egg white are ovalbumin and ovotransferrin. The sample also contains five pI markers: the dansyl derivatives of three amino acids (DNS-Asp, DNS-Phe and DNS-Trp) and two aminophenols (terbutaline and tyramine). There are no auxiliary agents added to the sample. After isoelectric focusing the most acidic pl marker, DNS-Asp is at the anodic end of the viewing area of the separation capillary (at approximately 0 pixel), tyramine is at the cathodic end of the viewing area (at approximately 2050 pixel). The bottom panel shows that the addition of arginine as a cathodic auxiliary agent to the same chicken egg white sample shifts the bands of all ampholytic sample components in the separation capillary towards the anode: DNS-Asp leaves the viewing area at the anodic end of the separat ion capillary, while tyramine moves further into the separation capillary (to approximately 1950 pixel), demonstrating that the addition of a cathodic auxiliary agent shifts the pH gradient toward the anode.

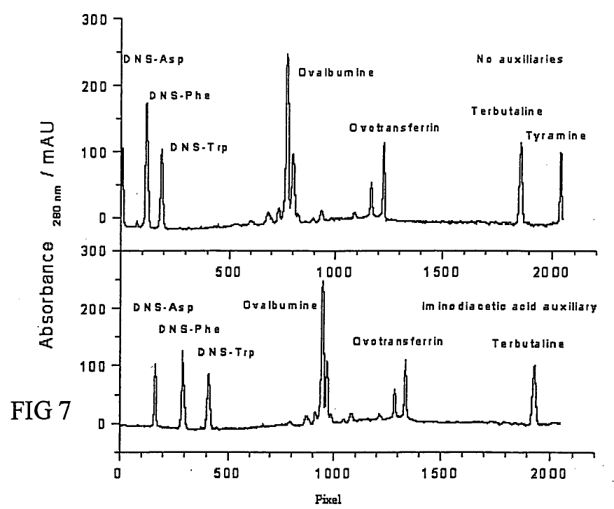

FIG. 7 shows an iCIEF electropherogram of a chicken egg white sample taken without the addition of an auxiliary agent (top panel) compared to an iCIEF electropherogram of a chicken egg white sample taken with an anodic auxiliary agent added (bottom panel) and demonstrates the shifting and compression effect of the anodic auxiliary agent added to the sample. The detector trace shown in top panel in FIG. 7 is the same as in the top panel of FIG. 6. The bottom panel shows that the addition of an anodic auxiliary agent, here iminodiacetic acid, shifts the pH gradient toward the cathode and causes the band of DNS-Asp to move from approximately 0 pixel (top panel) to approximately 170 pixel (bottom panel) and forces the band of tyramine (at approximately 2050 pixel in the top panel) out of the viewing area of the separation capillary toward the cathode.

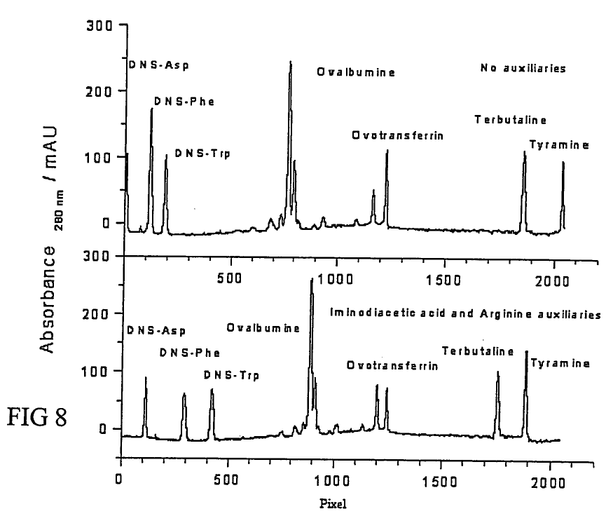

FIG. 8 shows an iCIEF electropherogram of a chicken egg white sample taken without the addition of an auxiliary agent (top panel) compared to an iCIEF electropherogram of a chicken egg white sample taken with both an anodic and a cathodic auxiliary agent added (bottom panel), and demonstrates the shifting and compression effects of the auxiliary agents added to the sample. The detector trace shown in top panel in FIG. 8 is the same as in the top panels of FIGS. 6 and 7. The bottom panel shows that the addition of a certain amount of iminodiacetic acid as an anodic auxiliary agent and arginine as a cathodic auxiliary agent compresses the pH gradient from both the anodic end and the cathodic end causing the band of DNS-Asp to move from approximately 0 pixel (top panel) to approximately 110 pixel (bottom panel), and the band of tyramine to move from approximately 2050 pixel (top panel) to approximately 1880 pixel (bottom panel).

### EXAMPLE 2

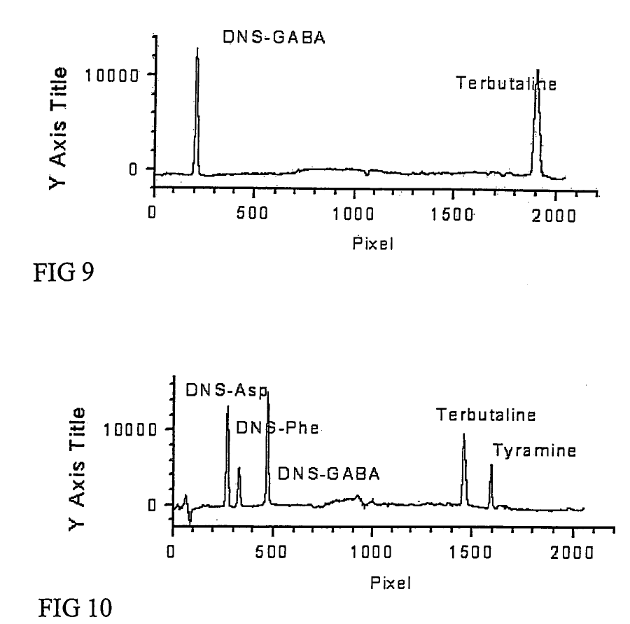

FIGS. 9-12 show the use of anodic and cathodic auxiliary agents to eliminate: compression of the pH gradient that was caused by the presence of salt in the sample. The sample is a mixture of pI markers DNS-Asp, DNS-Phe, DNS-Trp, terbutaline and tyramine, dissolved in 8% pH 3-10 Ampholine carrier ampholytes.

FIG. 9 shows the detector trace obtained for the pI marker sample in the iCIEF instrument, without any added auxiliary agent. On the anodic side, only the least acidic pI marker, DNS-GABA is visible at approximately 200 pixels. On the cathodic side, only the least basic pI marker, terbutaline is visible at approximately 1900 pixels. The other four pI markers focus outside the viewing area of the separation capillary.

FIG. 10 shows the detector trace obtained in the iCIEF instrument for the pI marker sample after iminodiacetic acid and arginine were added to it as anodic and cathodic auxiliary agents. Now all five pI markers are visible in the electropherogram, because the auxiliary agents, 48 mM iminodiacetic acid and 24 mM arginine, compress the pH gradient from both the anodic and cathodic sides. The peak of DNS-GABA is now at approximately 480 pixels, that of terbutaline at approximately 1450 pixels.

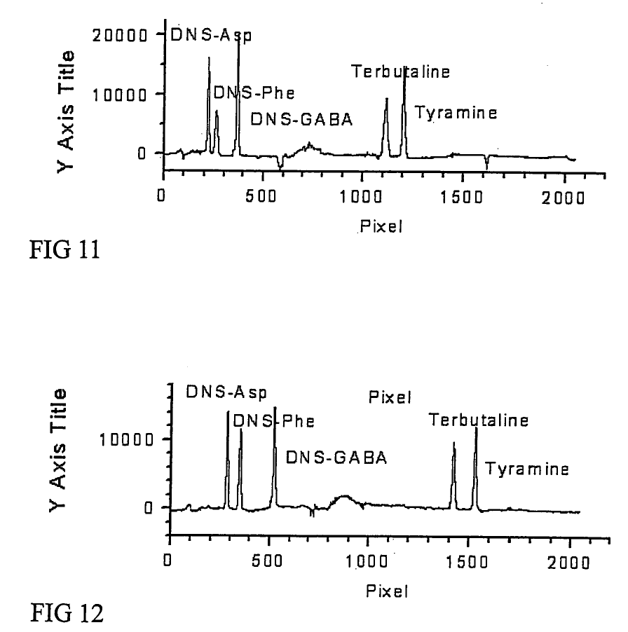

FIG. 11 shows the detector trace obtained in the iCIEF instrument for the pI marker sample used for FIG. 10, after the addition of 150 mM NaCl as salt. Clearly, the pH gradient is much more compressed: the peak of DNS-GABA is at approximately 380 pixels, that of terbutaline at approximately 1200 pixels, because acid and base formed from NaCl during IEF have invaded the anodic and cathodic extremes of the separation capillary.

FIG. 12 shows the detector trace obtained in the iCIEF instrument for the pI marker sample used for FIG. 11, except that the concentration of iminodiacetic acid has been reduced from 48 to 35 mM, that of arginine from 24 to 10 mM. The peak of DNS-GABA moved back to approximately 510 pixels, that of terbutaline to approximately 1540 pixels, indicating that the pH gradient could be restored to almost the same shape as before the addition of the 150 mM NaCl, shown in FIG. 10. Thus, the method of the invention can compensate for the compression of the pH gradient caused by the presence of salt, without removal of that salt prior to IEF separation.

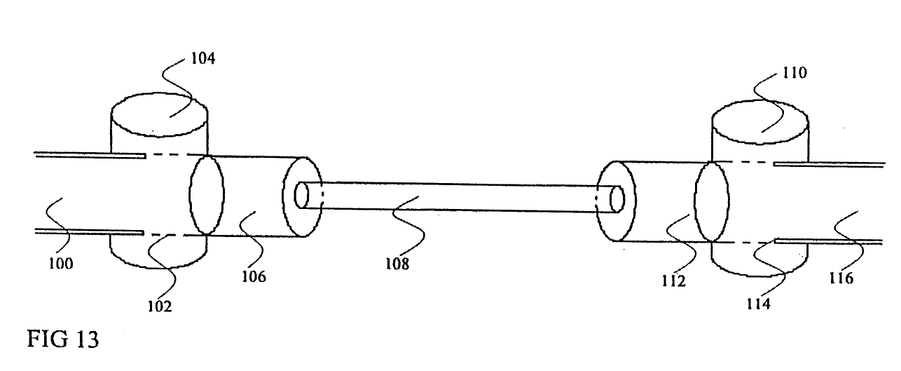

FIG. 13 is an illustration of a typical apparatus that can be used to practice the invention consisting of a separation capillary, two auxiliary compartments and two electrode compartments. The sample, mixed with the carrier ampholytes and the appropriate amounts of the auxiliary agents is fed into the apparatus at location 100 (or 116) and fills auxiliary compartments 106 and 112 and separation capillary 108. The sample flowing into the system passes by a membrane, 102, that separates anode compartment 104 from the anodic auxiliary chamber, 106. A membrane, 114, separates cathode compartment, 10 from the cathodic auxiliary chamber, 112. Anode compartment 104 contains an appropriate acidic solution, cathode compartment 110 contains an appropriate basic solution. During isoelectric focusing, the components of interest become focused into separation capillary 108, the anodic auxiliary agent fills the anodic auxiliary compartment, and the cathodic auxiliary agent fills the cathodic auxiliary compartment. After separation, the sample can leave the system via 116 (or 100).

### EXAMPLE 3

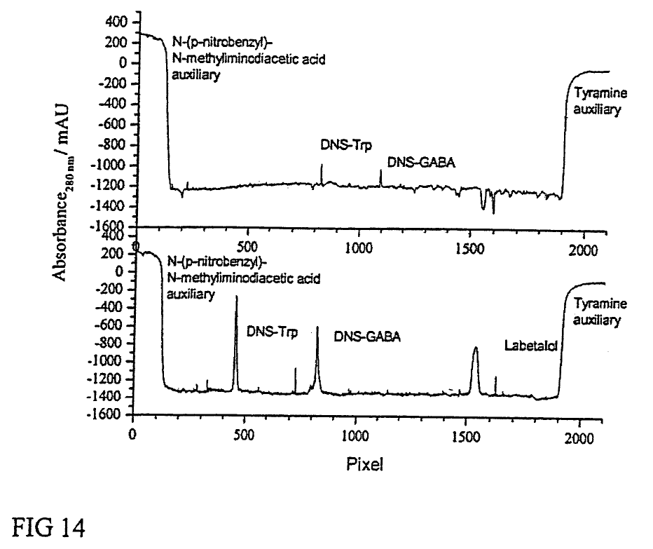

FIG. 14, in the top panel, shows an electropherogram of a sample containing DNS-Trp, DNS-GABA, and labetalol as components of interest in a pH 3-10 Ampholine carrier ampholyte solution, N-(p-nitrobenzyl)-N-methylaminodiacetic acid as an anodic auxiliary agent, tyramine as a cathodic auxiliary agent, obtained in an iCIEF system equipped with a conventional separation capillary that does not contain auxiliary compartments. The concentration of the anodic auxiliary agent, N-(p-nitrobenzyl)-N-methylaminodiacetic acid, has been adjusted to cause it to invade about the first 100 pixels worth of the separation capillary, creating an easily visible absorbance front. The concentration of the cathodic auxiliary agent, tyramine, has been adjusted to cause it to invade about the last 100 pixels worth of the separation capillary, creating another easily visible absorbance front. The concentration of the ampholytic sample components of interest is so low, that only a small peak is visible for DNS-Trp, another for DNS-GABA, but no peak is visible for labetalol.

The bottom panel of FIG. 14 shows an electropherogram for the same sample that was used for the top panel, except that this electropherogram was obtained in an iCIEF system that was equipped with a separation capillary attached to an anodic auxiliary compartment and a cathodic auxiliary compartment according to FIG. 13. The concentration of the anodic auxiliary agent, N-(p-nitrobenzyl)-N-methylaminodiacetic acid, and the concentration of the cathodic auxiliary agent, tyramine, has again been adjusted to cause them to invade about the first and the last 100 pixels of the separation capillary, respectively, creating easily visible absorbance fronts. Even though the concentration of the ampholytic sample components of interest in the feed sample was as low as in the top panel, the combined use of the anodic and cathodic auxiliary compartments and the anodic and cathodic auxiliary agents according to the present invention made their analysis and detection feasible.

While it is currently preferred to use both one or more auxiliary agents and one or more auxiliary compartments since the two work together as described to provide the best improved results, worthwhile improvement can be obtained by using either the addition of an auxiliary agent without the use of one or more auxiliary compartments or the use of one or more auxiliary compartments without the addition of one or more auxiliary agents.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

1. A method of improving a concentration detection limit for an ampholytic analyte in an isoelectric focusing system comprising the steps of:
providing an isoelectric focusing system having a separation compartment disposed between an anode compartment and a cathode compartment;
providing a solution containing an ampholytic analyte and a mixture of carrier ampholytes;
providing at least one of the options selected from the group consisting of option one and option two, wherein option one uses one or more auxiliary compartments disposed between at least one of the anode compartment and the separation compartment or the cathode compartment and the separation compartment, and option two uses one or more auxiliary agents mixed with the solution containing the ampholytic sample component;
filling the anode compartment with an acidic solution and the cathode compartment with a basic solution;
filling the other compartments with the solution containing the ampholytic analyte;
applying a potential between an anode located in the anode compartment and a cathode located in the cathode compartment and effecting an isoelectric focusing of the ampholytic analyte into the separation compartment; and
detecting the focused ampholytic analyte in the separation compartment at its increased concentration over that provided by isoelectric focusing without the use of option one or option two.

2. A method of improving a concentration detection limit for an ampholytic analyte in an isoelectric focusing system and eliminating a deformation of a pH gradient in the isoelectric focusing analysis of a salt-laden sample containing an ampholytic analyte comprising the steps of:
providing an isoelectric focusing system having a separation compartment disposed between an anode compartment and a cathode compartment;
providing one or more auxiliary compartments disposed between at least one of the anode compartment and the separation compartment or the cathode compartment and the separation compartment;
adding a mixture of carrier ampholytes and a first amount of one or more auxiliary agents to the salt-laden sample solution containing the ampholytic analyte;
filling the anode compartment with an acidic solution and the cathode compartment with a basic solution;
filling the other compartments with the solution containing the ampholytic analyte;
applying a potential between an anode located in the anode compartment and a cathode located in the cathode compartment and effecting a first isoelectric focusing of the ampholytic analyte into the separation compartment;
detecting at a first focusing position in the separation compartment the focused ampholytic analyte;
adjusting the first amount of the one or more auxiliary agents added to the salt-laden sample solution containing the ampholytic analyte to. a second amount and effecting a second isoelectric focusing of the ampholytic analyte into the separation compartment; and
detecting at a desired second focusing position in the separation compartment the focused ampholytic analyte at its increased concentration over that provided in an isoelectric focusing without the use of an auxiliary compartment or an auxiliary agent.

3. A method according to claim 1 or 2, wherein the isoelectric focusing system is a capillary isoelectric focusing system.

4. A method according to claim 1 or 2, wherein the isoelectric focusing system is an imaging capillary isoelectric focusing system.

5. A method according to claim 1 or 2, wherein the isoelectric focusing system is a chip-based isoelectric focusing system.

6. A method according to claim 1 or 2, wherein the isoelectric focusing system is a chip-based imaging isoelectric focusing system.

7. A method according to claim 1 or 2, wherein the auxiliary compartment and the adjacent electrode compartment are separated by an anti-convective, ion-permeable barrier that substantially eliminates convective mixing between the contents of the auxiliary compartment and the adjacent electrode compartment.

8. A method according to claim 1 or 2, wherein the auxiliary compartment and the adjacent electrode compartment are separated by an anti-convective, ion-permeable membrane that substantially eliminates convective mixing between the contents of the auxiliary compartment and the adjacent electrode compartment.

9. A method according to claim 1 or 2, wherein any auxiliary agent used is selected from a group consisting of subgroups of strong electrolytes, weak electrolytes, and ampholytes.

10. A method according to claim 1 or 2, wherein the multiple auxiliary agents used are selected to belong to the same or different subgroups of strong electrolytes, weak electrolytes, and ampholytes.

11. A method according to claim 1 or 2, wherein the difference between the pI value of the ampholytic auxiliary agent and its nearest pKa value is less than 2.

12. A method according to claim 1 or 2, wherein the difference between the pI value of the ampholytic auxiliary agent and its nearest pKa value is less than 1.

13. A method according to claim 1 or 2, wherein the difference between the pI value of the ampholytic auxiliary agent and its nearest pKa value is less than 0.75.

14. A method according to claim 1 or 2, wherein the pI value of one or more of the ampholytic auxiliary agents is lower than the pI value of the most acidic ampholytic analyte of interest or higher than the pI value of the most basic ampholytic analyte of interest.

15. A method according to claim 1 or 2, wherein one or more of the auxiliary agents absorb light at a selected detection wavelength.

16. A method according to claim 1 or 2, wherein one or more of the auxiliary agents fluoresce.

17. A method according to claim 1 or 2, wherein one or more of the ampholytic auxiliary agents are selected from a group consisting of cysteic acid, N,N-dimethyliminodiacetic acid, N-methylaminodiacetic acid, iminodiacetic acid, berizeneiminodiacetic acid, aspartic acid, glutamic acid, omithine, lysine, terbutaline, tyramine, arginine.

18. A method according to claim 1 or 2, wherein any member of a group consisting of hydronium, lithium, sodium, potassium, tetramethylammonium, tetraethylammonium, tetrapropylammonium, tetrabutylammonium, benzyltrimethylammonium, benzyltriethylammonium, benzyltripropylammonium, beenzyltributylammonium, alkoxybenzyltrimethylammonium ions can be used as a non-hydrolyzing cation for the strong or weak electrolyte auxiliary agent, and any member of a group consisting of hydroxide, chloride,, bromide, iodide, sulfate, nitrate, methanesulfonate, ethanesulfonate, benzenesulfonate, toluenesulfonate, naphthalenesulfonate, benzenedisulfonate, naphthalenedisulfonate and alkoxybenzenesulfonate ions can be used as a non-hydrolyzing anion for the strong or weak electrolyte auxiliary agent.

19. A method according to claim 1 or 2, wherein any member of a group consisting of ammonium, monoalkylammonium, dialkylammonium, trialkylammonium, arylalkylammonium, alkoxyarylalkylammonium ions can be used as a hydrolyzing cation for the weak electrolyte auxiliary agent, and any member of a group consisting of alkylcarboxylate, arylcarboxylate, alkylarylcarboxylate, alkoxyarylcarboxylate, phenolate and alkoxyphenolate ions can be used as a hydrolyzing anion for the weak electrolyte auxiliary agent.

20. A method according to claim 1 or 2, wherein one or more solubilizer selected from a group consisting of non-electrolytes and .zwitterions is additionally added to the sample solution to increase the solubility of the ampholytic analyte.

21. A method according to claim 1 or 2, wherein one or more complexing agent selected from group consisting of non-electrolytes and zwitterions is additionally added to the sample solution to improve the isoelectric focusing separation of the ampholytic analyte.

22. An apparatus comprising:
a separation compartment disposed between an anode compartment and a cathode compartment;
an anode disposed in the anode compartment and a cathode disposed in the cathode compartment;
one or more auxiliary compartments disposed between the anode compartment and the separation compartment or the cathode compartment and the separation compartment;
a means of filling the anode compartment with an acidic solution and the cathode compartment with a basic solution;
a means of filling the rest of the compartments with a solution that contains an ampholytic analyte, and one or more components selected from a group comprising a mixture of carrier ampholytes, strong electrolyte auxiliary agents, weak electrolyte auxiliary agents, and ampholytic auxiliary agents;
a means of applying a separation potential to the anode and the cathode and effecting an isoelectric focusing of the ampholytic analyte into the separation compartment; and
a means of detecting the focused ampholytic analyte in the separation compartment at its increased concentration over that provided by isoelectric focusing without the use of any auxiliary compartment and auxiliary agent.

23. An apparatus comprising:
a separation compartment disposed between an anode compartment and a cathode compartment;
an anode disposed in the anode compartment and a cathode disposed in the cathode compartment;
one or more auxiliary compartments disposed between the anode compartment and the separation compartment or the cathode compartment and the separation compartment;
a means of filling the anode compartment with an acidic solution and the cathode compartment with a basic solution;
a means of filling the rest of the compartments with a solution that contains an ampholytic analyte present in a salt-laden sample and a first amount of one or more components selected from a group comprising a mixture of carrier ampholytes, strong electrolyte auxiliary agents, weak electrolyte auxiliary agents, and ampholytic auxiliary agents;
a means of applying a separation potential to the anode and the cathode and effecting a first isoelectric focusing of the ampholytic analyte into the separation compartment;
a means of detecting at a first focusing position in the separation compartment the focused ampholytic analyte at its increased concentration;
a means of adjusting in the ampholytic analyte containing solution the first amount of the one or more components selected from the group comprising a mixture of carrier ampholytes, strong electrolyte auxiliary agents, weak electrolyte auxiliary agents, and ampholytic auxiliary agents to a second amount and effecting a second isoelectric focusing of the ampholytic analyte; and
a means of detecting at a desired second focusing position in the separation compartment the ampholytic analyte at its increased concentration over that provided by isoelectric focusing without the use of any auxiliary compartment and auxiliary agent.

24. An apparatus according to claim 22 or 23, wherein there is one auxiliary compartment disposed between the anode compartment and the separation compartment and another auxiliary compartment disposed between the separation compartment and the cathode compartment;

25. An apparatus according to claim 22 or 23, wherein the separation compartment is part of a capillary isoelectric focusing system.

26. An apparatus according to claim 22 or 23, wherein the separation compartment is part of an imaging capillary isoelectric focusing system.

27. An apparatus according to claim 22 or 23, wherein the separation compartment is part of an isoelectric focusing system.

28. An apparatus according to claim 22 or 23, wherein the separation compartment is part of an imaging isoelectric focusing system.

29. An apparatus according to claim 22 or 23, additionally including an anti-convective, ion-permeable barrier between the auxiliary compartment and the adjacent electrode compartment that substantially eliminates convective mixing between the contents of the auxiliary compartment and the adjacent electrode compartment.

30. An apparatus according to claim 22 or 23, additionally including an anti-convective, ion-permeable membrane between the auxiliary compartment and the adjacent electrode compartment that substantially eliminates convective mixing between the contents of the auxiliary compartment and the adjacent electrode compartment.

31. An apparatus according to claim 22 or 23, wherein the means of detection is a light absorbance detector.

32. An apparatus according to claim 22 or 23, wherein the means of detection is a fluorescence detector.

33. An apparatus according to claim 22 or 23, wherein the means of detection is an imaging light absorbance detector.

34. An apparatus according to claim 22 or 23, wherein the means of detection is an imaging fluorescence detector.

35. A method of improving a concentration detection limit for an ampholytic analyte in an isoelectric focusing system, comprising the steps of:
providing an isoelectric focusing system including a separation compartment disposed between an anode compartment having an anode therein and a cathode compartment having a cathode therein;
providing a solution containing an ampholytic analyte and a mixture of carrier ampholytes;
mixing at least one auxiliary agent with the solution containing the ampholytic analyte and mixture of carrier amphlytes;
filling the anode compartment with an acidic solution and the cathode compartment with a basic solution;
filling the separation compartment with the solution containing the ampholytic analyte, mixture of carrier amphlytes, and at least one auxiliary agent;
applying a potential between the anode located in the anode compartment and the cathode located in the cathode compartment to effect an isoelectric focusing of the ampholytic analyte in the separation compartment; and
detecting the focused ampholytic analyte in the separation compartment at its increased concentration over that provided by isoelectric focusing without the use of the at least one auxiliary agent.

36. A method of improving the concentration detection limits in an isoelectric focusing system according to claim 35, additionally including the step of adding at least one auxiliary compartment disposed between at least one of the anode compartment and the separation compartment and the cathode compartment and the separation compartment, and filling, along with the separation compartment, the at least one auxiliary compartment with the solution containing the ampholytic analyte and mixture of carrier amphlytes.

37. A method of improving a concentration detection limit for an ampholytic analyte in an isoelectric focusing system, comprising the steps of:
providing an isoelectric focusing system including a separation compartment disposed between an anode compartment having an anode therein and a cathode compartment having a cathode therein;
providing a solution containing an ampholytic analyte and a mixture of carrier ampholytes;
providing at least one auxiliary compartment disposed between at least one of the anode compartment and the separation compartment and the cathode compartment and the separation compartment;
filling the anode compartment with an acidic solution and the cathode compartment with a basic solution;
filling the separation compartment and the, at least one auxiliary compartment with the solution containing the ampholytic analyte and mixture of carrier amphlytes;
applying a potential between the anode located in the anode compartment and the cathode located in the cathode compartment to effect an isoelectric focusing of the ampholytic analyte in the separation compartment; and
detecting the focused ampholytic analyte in the separation compartment at its increased concentration over that provided by isoelectric focusing without the use of the at least one auxiliary compartment.
